(19) United States
(12) Patent Application Publication
(10) Pub. No.: US 2002/0140820 A1
(43) Pub. Date: Oct. 3, 2002

(54) Calendar based photo browser

(76) Inventor: George R. Borden IV, Portland, OR (US)

Correspondence Address: Kevin L. Russell, Suite 1600, 601 SW Second Ave., Portland, OR, 97204-3157, US

(21) Appl. No.: 09/823,050

(22) Filed: Mar. 29, 2001

(51) Int. Cl. H04N 5/225; G06K 9/36

(52) U.S. Cl. 348/207.99; 382/284

(57) ABSTRACT

A system for presenting a plurality of digital images, each of which has a corresponding associated date, using a display having a calendar based interface.

### BACKGROUND OF THE INVENTION

The present invention relates to a calendar based photo browser.

With the emergence of affordable digital cameras many users of such digital cameras are amassing a large number of digital images. The digital images are typically stored on the user's hard drive or other recordable media in one or more directories. In addition, many users take pictures using film or slides, and thereafter scan the film or slides to obtain digital images. After extensive use, or prolonged use of cameras, the user may amass thousands of such digital image files. It is frustrating for the user to have to search through thousands of digital images to locate ones of interest or locating a particular digital image that the user vaguely remembers taking years ago on a trip to Paris.

One technique to attempt to categorize digital image files is to place all of them in a single directory and search through them in a sequential order until the desired digital image file is located. Unfortunately, this takes considerable time and is frustrating for the user.

An improved technique to categorize digital image files is to place them in different directories according to their subject matter, such as horses, people, family, and Yellowstone. While somewhat of an improvement, it still takes considerable time to locate particular digital image files within all of the potential directories. In addition, it takes considerable time to organize the files into suitable directories.

Another technique to categorize digital image files involves using a thumbnail generating program, together with a filing system, to preview each of the digital image files on the screen in a smaller format. In this manner, dozens of images may be simultaneously displayed on the screen from which the user may select an appropriate digital image.

Another technique to organize digital image files include sorting the files by their creation date, such as first created to last created. This provides limited date organization to the digital image files, but again this results in merely another long list of files from which the user selects an appropriate file. Accordingly, this technique is generally unsatisfactory.

Yet another technique for the organization of digital image files is to provide a name for each image file which is descriptive of the contents depicted in the respective image file. Unfortunately, the number of letters available limits the descriptive context of the name, and it is generally undesirable to have long file names, such as for example, “familyatthebeachontherocks.gif”. In addition, the naming of individual files in this manner is time consuming for the user. Accordingly, the user typically just neglects to name the image files in any meaningful manner.

Some software programs permit the user to append textual information to the image file itself, or otherwise a file associated with the image file, describing the contents of the image. This permits the user to effectively categorize the image files, but unfortunately this relies on the user manually entering all of the textual information which is time consuming. Accordingly, the user typically just neglects to provide textual annotations to the files.

### BRIEF DESCRIPTION OF THE DRAWINGS

FIG. 1 is a pictorial representation of an exemplary embodiment of a calendar based presentation of digital image files.

FIG. 2 is a pictorial representation of an alternative exemplary embodiment of a calendar based presentation of digital image files.

FIG. 3 is a pictorial representation of another alternative exemplary embodiment of a calendar based presentation of digital image files.

FIG. 4 is a pictorial representation of yet another alternative exemplary embodiment of a calendar based presentation of digital image files.

FIG. 5 is a pictorial representation of a further alternative exemplary embodiment of a calendar based presentation of digital image files.

FIG. 6 is a pictorial representation of a further alternative exemplary embodiment of a calendar based presentation of digital image files.

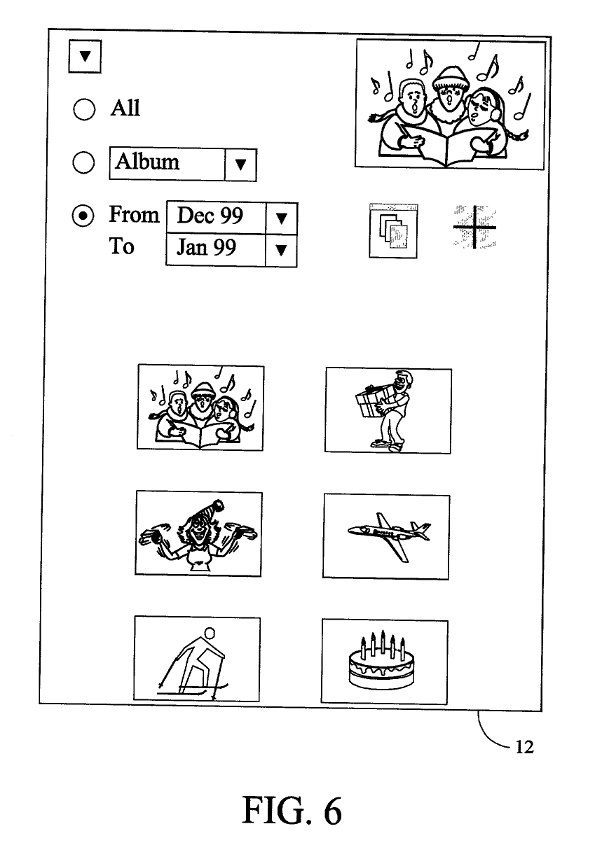

### DETAILED DESCRIPTION OF THE PREFERRED EMBODIMENT

After consideration of the limitations of the existing techniques for the organization of digital image files, the present inventor considered existing digital image files and determined that most, if not all, include a creation date. Similarly, the digital image files resulting from the scanning of film, slides, or pictures likewise normally includes the date upon which the film, slides or pictures are scanned. Also, the creation date is normally automatically associated with the corresponding file so the user is free from having to manually associate a creation date with the digital image file. In particular, the present inventor further realized that people typically are aware of when they took pictures, such as Paris pictures taken in July 1997, but not the particular names attributed to those files. Further, pictures of a particular date or range of dates, tend to be correlated in their content, such as Pictures taken in July and August relating to a trip to Paris. With the identification of the creation date as important, which requires little or no effort on the part of the user to associate with each file, the present inventor then considered how to organize such files, with the premise that the creation date should be used, at least in part, to organize the files. This construct is in direct contrast to the traditional technique of attempting to organize files solely by their content.

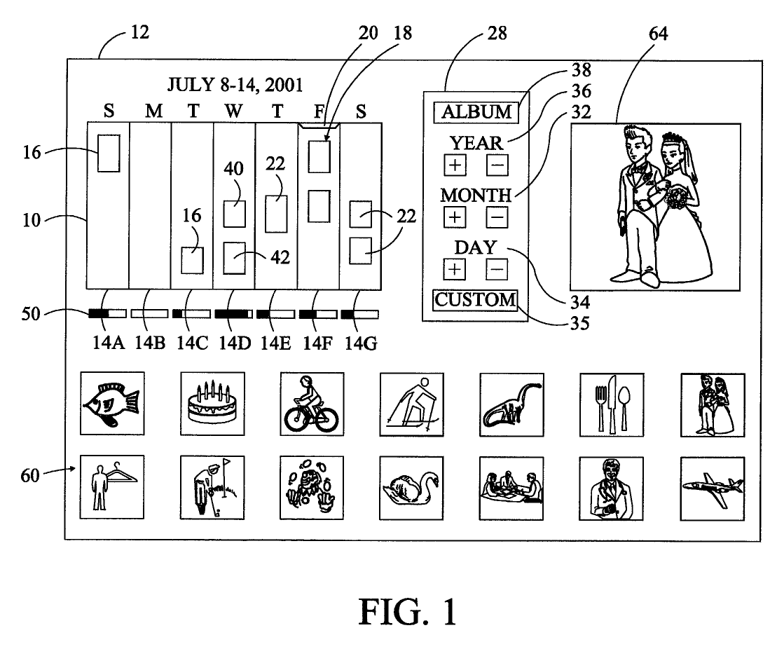

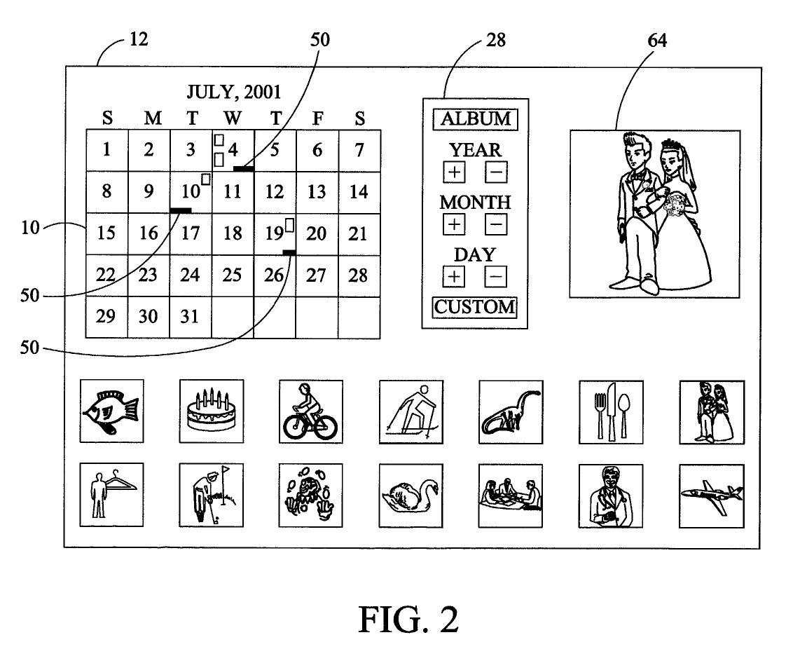

The present inventor determined that the organization of the files should be based upon a familiar construct so that the user can readily locate the files, namely, a calendar based presentation. Referring to FIG. 1, a calendar 10 may be presented to the user on a display 12, such as a monitor on a personal computer or other electronic display device. The calendar 10 may be further subdivided to a plurality of dates, such as Sunday 14a, Monday 14b, Tuesday 14c, Wednesday 14d, Thursday 14e, Friday 14f, and Saturday 14g. Referring to FIG. 2, the calendar may be further subdivided into a plurality of dates of the month. Alternatively, the calendar may be subdivided into regions, each of which is representative of one or more calendar days, in any format desired.

Each of the digital image files obtained by the user has an associated date with it, which may be the file creation date or any other date associated with the file. The date may indicate, for example, the year, the decade, the month, the day, the hour, the minute, the second, a range of dates, the morning, the evening, and/or the afternoon. The digital image files are then associated with the corresponding date or date range of the particular calendar presented. In this manner, all of the digital image files are categorized, preferably in an automatic fashion, with the corresponding date or date range of the calendar. Accordingly, the user need merely select the desired date range, such as July 1997 when the user traveled to Paris, and the corresponding digital image files 16 will be presented to the user. Rescaling the date ranges results in regrouping of the files within the new date ranges.

Preferably, the calendar 10 signifies the existence of corresponding digital image files together with the presentation of the date ranges. The indication of the existence of the corresponding digital image files may be presented as an icon 18 in the spatial region 20 corresponding to the date range. The indication of the existence of the corresponding digital image files may be presented to the user using any other suitable technique. To further decrease the frustration to the user in the identification of particular digital image files, and to what image content the digital image files are representative of, the system may present a thumbnail view 22 of one or more of the corresponding digital image files. The particular thumbnail view 22 may be selected by the user for a particular group of files, or otherwise calculated by the system as the most representative file from a group of files. Moreover, the thumbnail view 22 may be selected in any manner.

The display 12 may further include a selection region 28, wherein the user may increment/decrement the year 30, increment/decrement the month 32, increment/decrement the day 34, or modify any other parameter that changes the calendar representation. The corresponding range of dates for each of the regions may be changed, such as the year, the month, the day, or otherwise. Likewise, the user may select a custom button 35 to select any suitable range of dates and presentation criteria desirable by the user.

While it may be useful to associate all available digital image files with the calendar 10, it may be advantageous to organize different digital image files by album 38, or otherwise into different groups. Each digital image file may be associated with one or more albums 38. This permits the user to present or otherwise refine the presentation of the digital image files selecting one or more albums 38. The digital images from multiple selected albums may be simultaneously displayed in the calendar as one collective group.

The digital image files within a particular region 20 may be further subdivided into one or more individual groups, such as groups 40 and 42. The arrangement of the groups 40 and 42 may be based upon other characteristics of the digital image files, such as for example, name, content, textual annotations, etc. In addition, the arrangement of the groups 40 and 42 may be based upon the creation date of the digital image files. Further, the arrangement of the groups 40 and 42 may be based upon an increasing date in accordance with the date order of the calendar, such as multiple views 22, with the views 22 arranged with the later dates toward the lower portion of the date 14. In addition, the position of each view 22 may be located with the date 14 in a location representative of the date of the file. For example, views 22 representative of the morning may be located higher within the respective date region, than views 22 representative of the evening. In addition, the interface may provide indicators 50 for each date region that indicate the number of digital image files associated with the respective date region. In this manner, the user can readily determine an estimated number of digital image files without having to examine the contents of the digital image files within a particular date region.

The display 12 may likewise include thumbnail views 60 of the digital image files within one or more selected date regions. This provides a convenient manner for inspection of the digital image files. Further, the display 12 may include a larger view 64 of a selected digital image file. This permits the user to more closely examine the contents of a particular digital image file.

When the date ranges or other properties to the calendar 10 are determined or otherwise presented, the corresponding thumbnail images are automatically presented. In this manner, the thumbnail images reflect one or more of the currently displayed date ranges of the calendar or the selected date range. Further, the larger view 64 may likewise be dynamically updated or otherwise remain constant until another thumbnail view is selected.

After using the calendar paradigm to locate suitable files, the user may create named albums by selecting desired thumbnail images and assigning them to another album. In this manner, the calendar based presentation technique may be used to sort the digital image files without having to explicitly type information regarding the files. In addition, the photos from a particular album may be exported or otherwise transferred as a group of digital image files to other applications, storage devices, or otherwise.

As it may be observed, the features of a calendar based presentation technique for digital image files, permits the user to organize and view his files in a manner that does not quire any tedious classification by the user. Without any tedious classification the user may be more likely to categorize and use his digital image files.

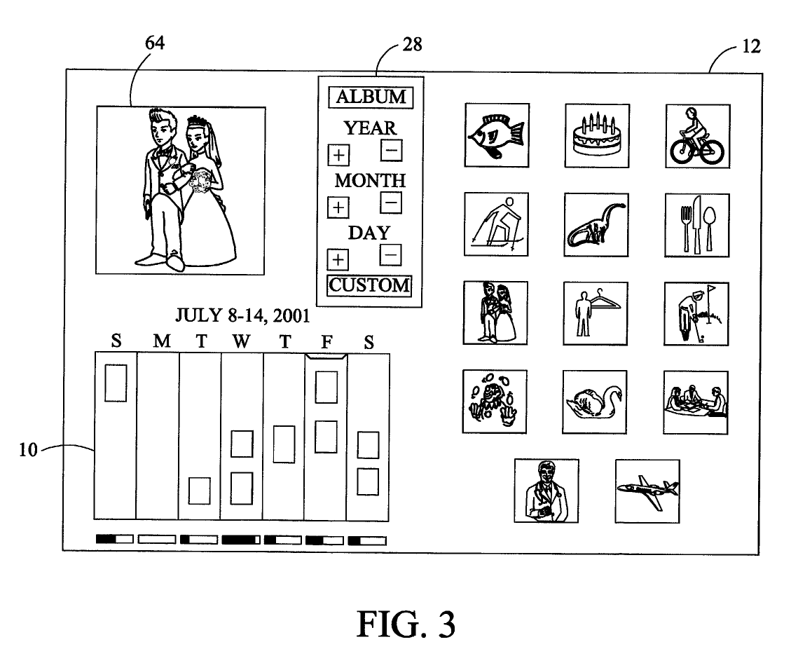

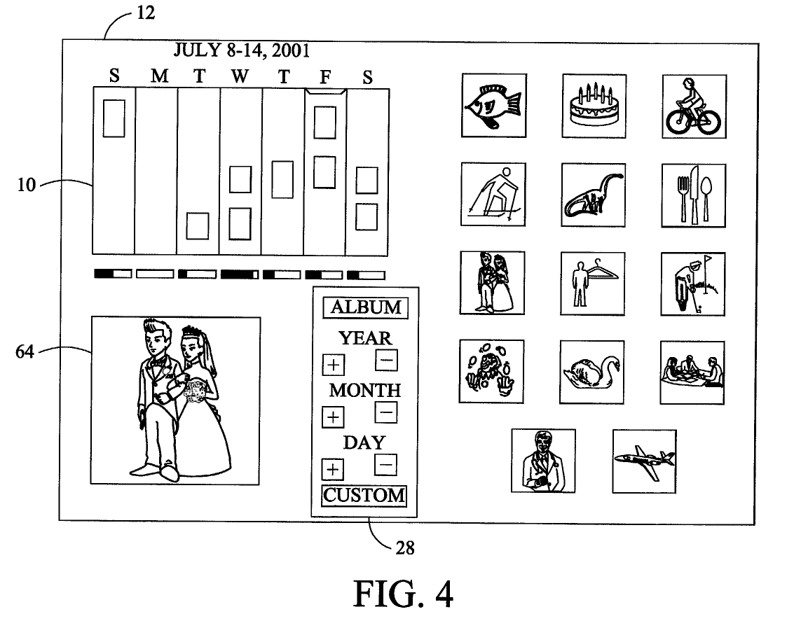

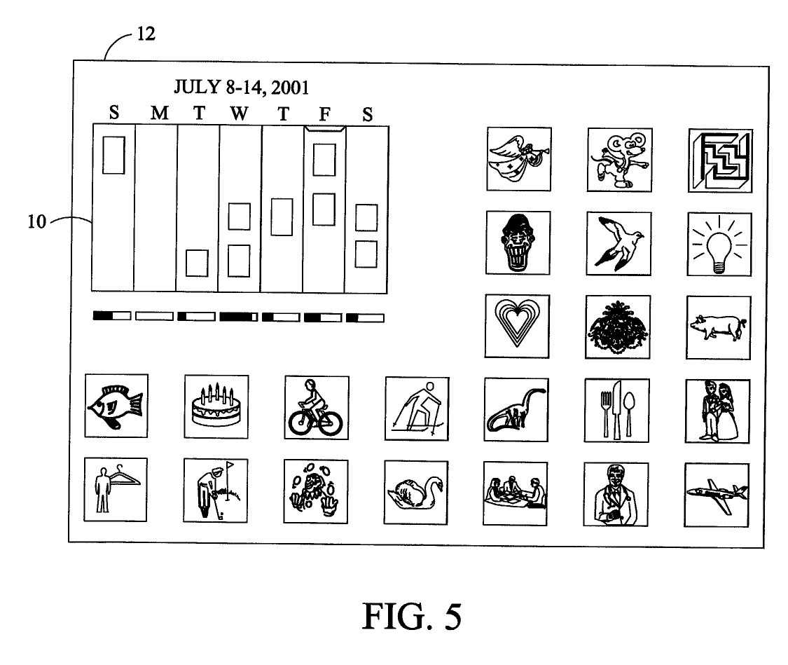

After further consideration, the present inventor determined that the preferred sizes of the calendar portion of the image is not merely an arbitrary selection, but rather should encompass between 15 percent and 30 percent of the entire display area, for effective use of the display together with thumbnails and large image(s), if desired. Further the calendar is preferably positioned in the upper left portion of the display. FIGS. 3, 4, and 5 illustrate other alternative positions for the calendar, thumbnail views, and large image(s). It is to be understood that the calendar, thumbnail views, and large image(s) may be located anywhere on the display, as desired. Moreover, the digital image files do not necessarily need to be stored in a file on a storage medium. It is sufficient that the digital images are presented, using the calendar based system, to the user.

It is to be understood that while the system is described in terms of digital images, it is likewise applicable to digital video, each of which typically comprises a plurality of frames. Likewise, when the calendar is scrolled or otherwise the date range is changed, the thumbnail presentations preferably automatically change. In the case that the calendar is presented in a vertical orientation, or the area used on the display has a larger vertical aspect than horizontal aspect, the thumbnail images are preferably likewise vertically oriented. Also, the calendar is preferably located above all or a majority of the thumbnails, which adds to ease of use.

The terms and expressions employed in the foregoing specification are used therein as terms of description and not of limitation, and there is no intention in the use of such terms and expressions of excluding equivalents of the features shown and described or portions thereof, it being recognized that the scope of the present invention is defined and limited only by the claims that follow.

1. A system for presenting at least one of digital images and digital video to a user comprising:
(a) a plurality of at least one of digital images and digital video each of which has a corresponding associated date;
(b) a display suitable for displaying a calendar based interface;
(c) said calendar based interface defining a plurality of date ranges; and
(d) associating each of at least one of said plurality of digital images and digital video with a corresponding one of said date ranges.

2. The system of claim 1 wherein at least one of said plurality of digital images and digital video are stored in a file.

3. The system of claim 1 wherein at least one of each of said digital images and digital video originated from a digital camera.

4. The system of claim 1 wherein at least one of each of said digital images and digital video originated from a scanning device.

5. The system of claim 1 wherein said associated date is the date upon which at least one of said digital image and digital video was created.

6. The system of claim 1 wherein said associated date for at least one of each of said digital images and digital video is created for the corresponding said at least one of said digital image and digital video free from a user manually assigning a creation date with said at least one of said digital image and digital video.

7. The system of claim 1 wherein said calendar based interface includes a week display.

8. The system of claim 1 wherein said calendar based interface includes a month display.

9. The system of claim 1 wherein said calendar based interface includes a plurality of regions each of which has an associated one of said date ranges.

10. The system of claim 9 wherein said date ranges are one day.

11. The system of claim 9 wherein said date ranges include a plurality of days.

12. The system of claim 1 further comprising at least one of said at least one of said plurality of digital images and digital video is associated with a plurality of said date ranges.

13. The system of claim 1 wherein said calendar based interface includes a morning display.

14. The system of claim 1 wherein said calendar based interface includes an evening display.

15. The system of claim 1 wherein said calendar based interface includes a morning display.

16. The system of claim 1 wherein said calendar based interface includes an indication of corresponding at least one of said digital images and digital video for at least one of said date ranges.

17. The system of claim 16 wherein said indication is provided in a spatial region of said display corresponding to said at least one of said date ranges.

18. The system of claim 17 wherein said spatial region includes a plurality of indications.

19. The system of claim 18 wherein said plurality of indications correspond with different groups of said plurality of at least one of digital images and digital video.

20. The system of claim 19 wherein said different groups are based upon, at least in part, different said associated dates.

21. The system of claim 1 wherein said date ranges are modified.

22. The system of claim 21 wherein at least one of said plurality of digital images and digital video are associated with corresponding said modified date ranges in accordance with said associated date of each respective at least one of said digital images and digital video.

23. The system of claim 22 wherein said modified association is performed free from said user manually associating any of at least one of said plurality of digital images and digital video.

24. The system of claim 1 further comprising displaying thumbnail images of at least one of said plurality of at least one of digital images and digital video associated with said date ranges.

25. The system of claim 24 further comprising displaying an larger view of at least one of said thumbnail images together simultaneously with said thumbnail images.

26. The system of claim 1 further comprising subdividing said plurality of at least one of digital images and digital video into a plurality of albums.

27. The system of claim 26 wherein said user selects at least one of said albums for the presentation of at least one of digital images and digital video.

28. The system of claim 27 wherein said user selects multiple albums for said presentation of at least one of digital images and digital video.

29. The system of claim 1 wherein said calendar occupies between 15 percent and 30 percent of the display area.

31. The system of claim 16 wherein said indication includes an area, and said area of said indication is associated with at least one of said digital images and digital video of said date ranges.

32. The system of claim 16 wherein said indication includes a color, and said color of said indication is associated with at least one of said digital images and digital video of said date ranges.
